(19) United States
(12) Patent Application Publication
(10) Pub. No.: US 2023/0398840 A1
(43) Pub. Date: Dec. 14, 2023

(54) APPARATUS FOR PREDICTING PERFORMANCE OF POWER WINDOW AND METHOD THEREOF

(71) Applicants: Hyundai Motor Company, Seoul (KR); Kia Corporation, Seoul (KR)

(72) Inventor: Sung Tae Choi, Gwangmyeong (KR)

(21) Appl. No.: 17/953,950

(22) Filed: Sep. 27, 2022

(30) Foreign Application Priority Data
Jun. 10, 2022 (KR) 10-2022-0070536

(51) Int. Cl. B60J 1/00; G06N 3/04; G06N 3/08

(52) U.S. Cl. CPC B60J 1/00; G06N 3/049; G06N 3/08

(57) ABSTRACT

The present disclosure relates to an apparatus for predicting performance of a power window and a method thereof. The apparatus for predicting performance of a power window may include a memory storage that stores a deep learning model and trained updates thereto and a controller that trains the deep learning model to predict the performance of the power window using a slide resistance of a glass run, a stroke distance of a door glass, a weight of the door glass, a torque of a motor, and a durability of the power window. The system may then predict performance of a target power window based on the deep learning model on which training has been performed.

### CROSS-REFERENCE TO RELATED APPLICATION

This application claims under 35 U.S.C. § 119(a) the benefit of and priority to Korean Patent Application No. 10-2022-0070536, filed in the Korean Intellectual Property Office on Jun. 10, 2022, the entire contents of which are incorporated herein by reference.

### BACKGROUND

### (A) Field of the Disclosure

The present disclosure relates to a technology for predicting the performance of a power window (window system) provided in a vehicle based on a deep learning model.

### (B) DESCRIPTION OF THE RELATED ART

Generally, Deep Learning (or Deep Neural Network) is a type of machine learning, in which a multi-layered artificial neural network (ANN) is configured between an input and an output. Such an artificial neural network may include a convolutional neural network (CNN), a recurrent neural network (RNN) or the like depending on structures, problem to be solved, and purpose.

Data input to the convolutional neural network is divided into a training set and a test set. The convolutional neural network learns the weights of the neural network through the training set, and checks results of the learning through the test set.

In such a convolutional neural network, input data is transformed into output in such a way that operation is performed sequentially from an input layer to a hidden layer. In this process, the input data passes through all nodes only once.

In this way, the fact that input data passes through all nodes only once means that the order of data, that is, the temporal aspect is not considered. After all, the convolutional neural network performs learning regardless of the temporal order of the input data. On the other hand, the recurrent neural network has a structure in which the result of the hidden layer is input to the hidden layer again. The structure means that the temporal order of the input data is considered.

However, the learning ability of the recurrent neural network decreases as the input data becomes longer. This is called the problem of Long Dependency. The greater the distance between the input data and the output data, the smaller the association. The recurrent neural network needs to rely on information from the past to get a present answer, but has a difficulty to solve the problem because the past is too far from the present in time.

A Long Short Term Memory (LSTM) has been proposed to solve the long dependency. The LSTM has three gates and two states: Forget Gate, Input Gate and Output Gate, Cell State and Hidden State.

On the other hand, since there is no conventional technique for predicting the performance of a power window, the performance of the power window has been measured using an actual measuring device. That is, the slide resistance of a glass run, the stroke distance of a glass, a weight of the glass, and the torque and durability of a motor are different between vehicle models, and accordingly, the operating current and operating time of the motor are different, so that the operating current and operating time of the motor are measured individually for each vehicle model.

According to the related art, it is necessary to repeatedly measure the operating current and operating time of the motor whenever a peripheral part (glass run, glass, motor, or the like) is replaced. Further, it is necessary to repeatedly measure the operating current and operating time of the motor whenever it is required to figure out the performance of the power window because the operating current and operating time of the motor are differently determined according to the durability of each peripheral part.

The matters described in this background are prepared to enhance an understanding of the background of the present disclosure, and may include matters other than the related art already known to those of ordinary skill in the field to which this technology belongs.

### SUMMARY

The present disclosure has been made to solve the above-mentioned problems occurring in the related art while advantages achieved by the related art are maintained intact.

An aspect of the present disclosure provides an apparatus for predicting performance of a power window and a method thereof, which train a deep learning model to predict the performance of a power window using a slide resistance of a glass run, the stroke distance of a glass, the weight of the glass, the torque of a motor, and the durability of the power window and predict the performance of the target power window based on the deep learning model on which the training has been performed, significantly reducing a required time and providing high-accuracy prediction results compared to a measurement method using an actual measuring device.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for predicting performance of a power window includes a memory storage that stores a deep learning model and trained updates thereto and a controller that trains the deep learning model to predict the performance of a power window using a slide resistance of a glass run, a stroke distance of a door glass, a weight of the door glass, a torque of a motor, and a durability of the power window and predicts performance of a target power window based on the deep learning model and trained updates thereto.

In an embodiment of the present disclosure, the apparatus may further include an input device that inputs: the slide resistance of the glass run, the stroke distance of the door glass, the weight of the door glass, the torque of the motor, and the durability of the power window as real data for the target power window.

In an embodiment of the present disclosure, the controller may predict an operating current and an operating time of the motor as the performance of the target power window by inputting the real data to the deep learning model.

In an embodiment of the present disclosure, the controller may replace the slide resistance of the glass run and the torque of the motor with different values in the real data when the predicted performance of the target power window does not satisfy designer's requirements and re-perform the predicted performance of the target power window as a re-prediction.

In an embodiment of the present disclosure, the controller may select training data including values similar to the stroke distance and weight of the door glass in the real data from among a plurality of pieces of training data, and replace the slide resistance of the glass run and the torque of the motor in the real data with a slide resistance of the glass run and a torque of the motor in the selected training data.

In an embodiment of the present disclosure, the controller may determine that the predicted performance of the target power window does not satisfy the designer's requirements when (a) the predicted operating current of the motor is greater than a reference current, and/or (b) the predicted operating time of the motor is greater than a reference time.

In an embodiment of the present disclosure, the apparatus may further include an output device that outputs the predicted performance of the target power window, and the controller may output the slide resistance of the glass run and the torque of the motor, the slide resistance of the glass run and the torque of the motor being replaced via the output device when the re-prediction performance of the target power window satisfies the designer's requirements.

In an embodiment of the present disclosure, the deep learning model may be implemented with a Long Short Term Memory (LSTM).

According to an aspect of the present disclosure, a method for predicting performance of a power window includes storing, by a memory storage, a deep learning model and trained updates thereto, training, by a controller, the deep learning model to predict the performance of a power window using: a slide resistance of a glass run, a stroke distance of a door glass, a weight of the door glass, a torque of a motor, and a durability of the power window, and predicting, by the controller, performance of a target power window based on the deep learning model and trained updates thereto.

In an embodiment of the present disclosure, the predicting of the performance of the target power window step may further include receiving the slide resistance of the glass run, the stroke distance of the door glass, the weight of the door glass, the torque of the motor, and the durability of the power window as real data for the target power window, and predicting an operating current and an operating time of the motor as the performance of the target power window by inputting the real data to the deep learning model.

In an embodiment of the present disclosure, the predicting of the performance of the target power window step may further include replacing the slide resistance of the glass run and the torque of the motor with different values in the real data when the predicted performance of the target power window does not satisfy designer's requirements and re-performing the predicted performance of the target power window as a re-prediction.

In an embodiment of the present disclosure, the re-performing of the predicted performance of the target power window step may further include selecting training data including values similar to the stroke distance and weight of the door glass in the real data from among a plurality of pieces of training data, and replacing the slide resistance of the glass run and the torque of the motor in the real data with a slide resistance of the glass run and a torque of the motor in the selected training data.

In an embodiment of the present disclosure, the re-performing the predicted performance of the target power window step may further include determining that the predicted performance of the target power window does not satisfy the designer's requirements when (a) the predicted operating current of the motor is greater than a reference current, and/or (b) the predicted operating time of the motor is greater than a reference time.

In an embodiment of the present disclosure, the predicting of the performance of the target power window step may further include outputting the slide resistance of the glass run and the torque of the motor, the slide resistance of the glass run and the torque of the motor being replaced when the re-prediction performance of the target power window satisfies the designer's requirements.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram showing an example of a power window (window system) used in an embodiment of the present disclosure;

FIG. 2 is a block diagram of an apparatus for predicting performance of a power window according to an embodiment of the present disclosure;

FIG. 3 is a diagram showing an example of training data provided in an apparatus for predicting performance of a power window according to an embodiment of the present disclosure;

FIG. 4 is a diagram showing an example of the deep learning model provided in an apparatus for predicting performance of a power window according to an embodiment of the present disclosure;

FIG. 5 is a diagram illustrating an example of a process of monitoring an operating current of a motor in a controller provided in an apparatus for predicting performance of a power window according to an embodiment of the present disclosure;

FIG. 6 is a diagram illustrating an example of a process of monitoring an operating time of a motor in a controller provided in an apparatus for predicting performance of a power window according to an embodiment of the present disclosure;

FIG. 7 is a flowchart of a method for predicting performance of a power window according to an embodiment of the present disclosure; and

FIG. 8 is a block diagram illustrating a computing system for performing a method for predicting performance of a power window according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A.”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

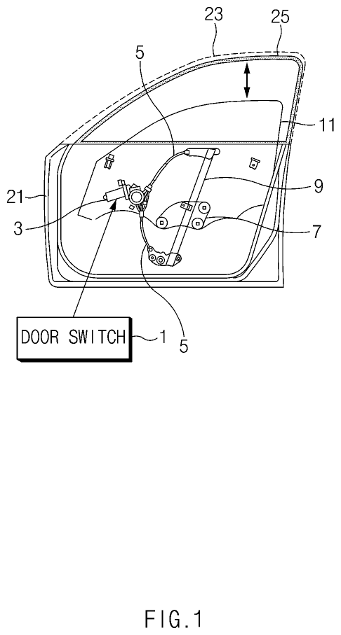

FIG. 1 is a diagram showing an example of a power window (window system) used in an embodiment of the present disclosure.

Referring to FIG. 1, a power window (window system) used in an embodiment of the present disclosure may include a door switch 1, a motor 3, a wire 5, a slider 7, a guide channel 9, a door glass 11, a door panel 21, a door frame 23, and a glass run 25.

When a passenger operates the door switch 1, the motor 3 may be driven, and as a result, the wire 5 may be wound or unwound, so that the slider 7 connected to the wire 5 slidably moves in the up/down direction according to the guide channel 9. Accordingly, the door glass 11 coupled with the slider 7 also may move in the up/down direction to open and close a window. Here, the maximum movement distance of the slider 7 in the guide channel 9, that is, the maximum movement distance of the door glass 11 is referred to as a stroke distance.

The glass run 25, usually made of rubber, may be integrally coupled to the door frame 23 which is integrally formed with the door panel 21 to support the edges of the door glass 11. The glass run 25 may serve as a guide when the door glass 11 moves up and down, and also serve to block the intrusion of foreign substances and driving noise by airtightness with the door glass 11. Here, the glass run 25 is generally made of rubber, so that resistance is caused when the door glass 11 is raised and lowered, which is referred to as slide resistance.

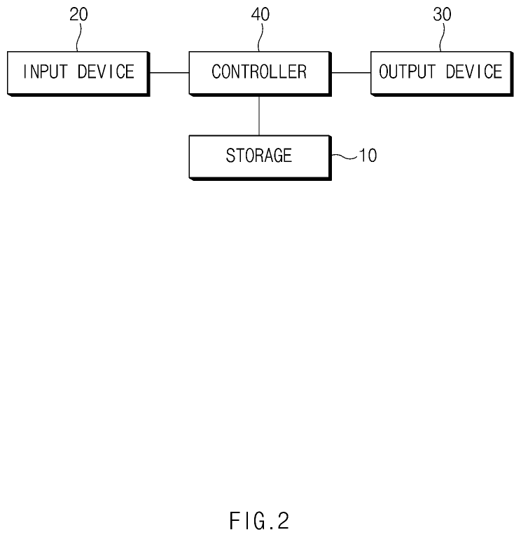

FIG. 2 is a block diagram of an apparatus for predicting performance of a power window according to an embodiment of the present disclosure.

Referring to FIG. 2, an apparatus for predicting performance of a power window according to an embodiment of the present disclosure may include a memory storage 10, an input device 20, an output device 30, and a controller 40. In this case, according to a method of implementing the apparatus for predicting performance of a power window according to an embodiment of the present disclosure, the components may be combined with each other as one entity, or some components may be omitted.

The components will be described in detail below. First, the memory storage 10 may store various logics, algorithms and programs required in the process of training a deep learning model to predict the performance of the power window using the slide resistance of the glass run 25, the stroke distance of the door glass 11, the weight of the door glass 11, the torque of the motor 3, and the durability of the power window and predicting the performance of a target power window based on the deep learning model on which the training has been performed. For reference, since the performance of the power window may be determined based on the operating current (current value) and operating time of the motor 3, the process of predicting the performance of the power window may ultimately mean a process of predicting the operating current and operating time of the motor 3. Here, the operating time of the motor 3 may ultimately represent a movement time of the door glass 11.

The memory storage 10 may further store a reference current as a reference used to determine whether the operating current of the motor 3 satisfies a designer's requirements.

The memory storage 10 may further store a reference time as a reference used to determine whether the operating time of the motor 3 satisfies the designer's requirements.

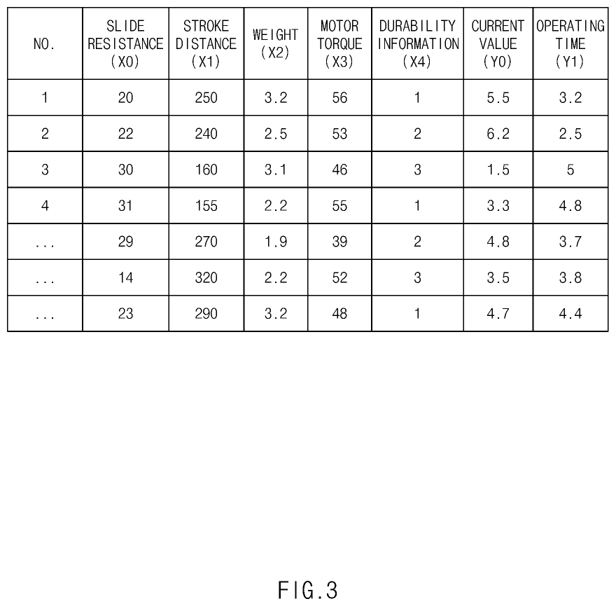

The memory storage 10 may store a plurality of pieces of training data having the slide resistance of the glass run 25, the stroke distance of the door glass 11, the weight of the door glass 11, the torque of the motor 3, and the durability of the power window as input variables, and the operating current and operating time of the motor 3 as output variables. Such training data is shown in FIG. 3 as an example.

FIG. 3 is a diagram showing an example of training data provided in an apparatus for predicting performance of a power window according to an embodiment of the present disclosure.

Referring to FIG. 3, there is difference between pieces of learning data in the slide resistance X0 of the glass run 25, the stroke distance X1 of the door glass 11, the weight X2 of the door glass 11, the torque X3 of the motor 3, and the durability X4 of the power window as input variables, and the operating current Y0 and operating time Y1 of the motor 3 as output variables. In this case, the durability X4 of the power window is an example of the durability information.

Here, the durability X4 of the power window may be determined according to the degree of deterioration. For example, when the number of times the power window is operated is 1,000 or less, the durability X4 may be set to 1, when the number of times the power window is operated is more than 1,000 and less than or equal to 10,000, the durability X4 may be set to 2, and when the number of times the power window is operated is greater than 10,000, the durability X4 may be set to 3. As another example, when the operating period of the power window is one year or less, the durability X4 may be set to 1, when the operating period of the power window is greater than one year and less than five years, the durability X4 may be set to 2, and when the operating period of the power window is greater than five years, the durability X4 may be set to 3.

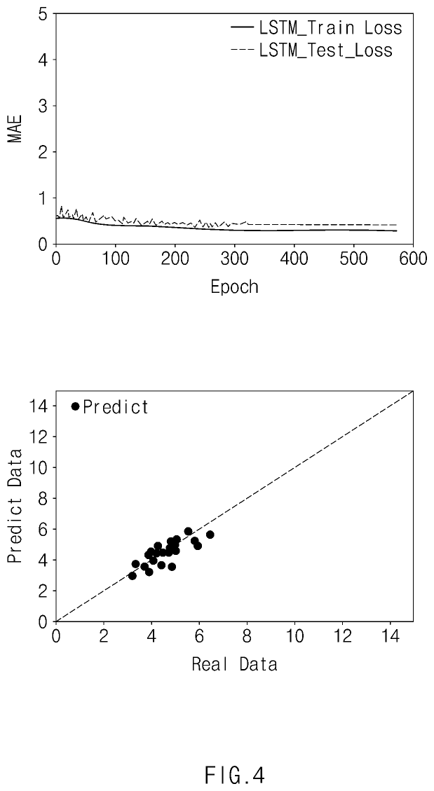

The memory storage 10 may store the trained deep learning model, and the deep learning model may be implemented with, for example, a Long Short Term Memory (LSTM). The performance of the deep learning model is as shown in FIG. 4 as an example.

FIG. 4 is a diagram showing an example of the deep learning model provided in an apparatus for predicting performance of a power window according to an embodiment of the present disclosure.

The deep learning model provided in the apparatus for predicting performance of a power window according to an embodiment of the present disclosure may be implemented with LSTM having, for example, five data features, three hidden layers, RMSProp (Root Mean Square Propagation) as an optimizer, and MAE (Mean Absolute Error) as matrics.

As shown in FIG. 4, it can be seen that the difference between the loss of training data (LSTM Train Loss) and the loss of test data (LSTM Test Loss) is insignificant in the LSTM. In particular, it can be seen that the accuracy is very high from the fact that the difference between the real data and the predicted data is 0.3.

The memory storage 10 may include at least one type of storage medium of memories such as a flash memory type memory, a hard disk type memory, a micro type memory, and a card type memory (e.g., an SD card (Secure Digital Card) or an XD card (eXtream Digital Card)), a RAM (Random Access Memory), an SRAM (Static RAM), a ROM (Read Only Memory), a PROM (Programmable ROM), a EEPROM (Electrically Erasable PROM), a MRAM (Magnetic RAM), and an optical disk type memory.

To predict the performance of the target power window, the input device 20 may input the slide resistance of the glass run 25, the stroke distance of the door glass 11, the weight of the door glass 11, and the torque of the motor 3 and the durability of the power window to the controller 40 as test data. In this case, the test data may mean real data of the target power window.

The output device 30 may output the performance of the target power window predicted by the controller 40. That is, the output device 30 may output the operating current and operating time of the motor 3 as factors indicating the performance of the target power window.

The output device 30 may output the slide resistance of the glass run 25 and the torque of the motor 3, replaced by the controller 40.

The controller 40 may perform overall control such that each of the above components normally performs its function. The controller 40 may be implemented in the form of hardware or software, or may be implemented in a combination of hardware and software. Preferably, the controller 40 may be implemented with a microprocessor, but is not limited thereto

The controller 40 may perform a variety of control required in the process of training a deep learning model to predict the performance of the power window using the slide resistance of the glass run 25, the stroke distance of the door glass 11, the weight of the door glass 11, the torque of the motor 3, and the durability of the power window and predicting the performance of a target power window based on the deep learning model on which the training has been performed.

The controller 40 may train the deep learning model using a plurality of training data as shown in FIG. 3. That is, the controller 40 may train the deep learning model to output an output variable corresponding to an input variable based on training data having the slide resistance of the glass run 25, the stroke distance of the door glass 11, the weight of the door glass 11, the torque of the motor 3, and the durability of the power window as input variables, and the operating current and operating time of the motor 3 as output variables.

Meanwhile, the controller 40 may determine whether a result of the prediction based on the test data input through the input device 20 satisfies the designer's requirements. In this case, when the result of the prediction does not satisfy the designer's requirements, the controller 40 may determine the slide resistance of the glass run 25 and the torque of the motor 3 satisfying the designer's requirements based on the plurality of pieces of learning data stored in the memory storage 10. In this case, because the slide resistance of the glass run 25 and the torque of the motor 3 are factors that have the greatest influence on the operating current of the motor 3, it is preferable to replace the factors when the prediction result does not satisfy the requirements of the designer.

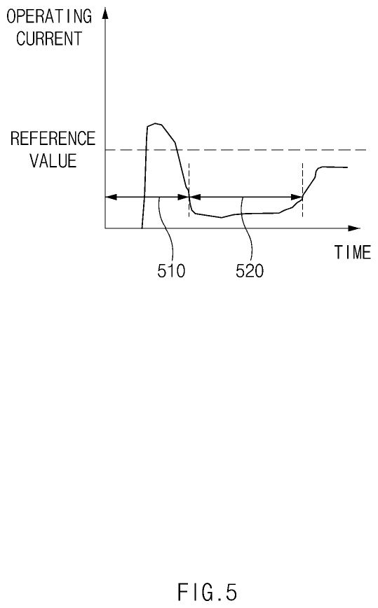

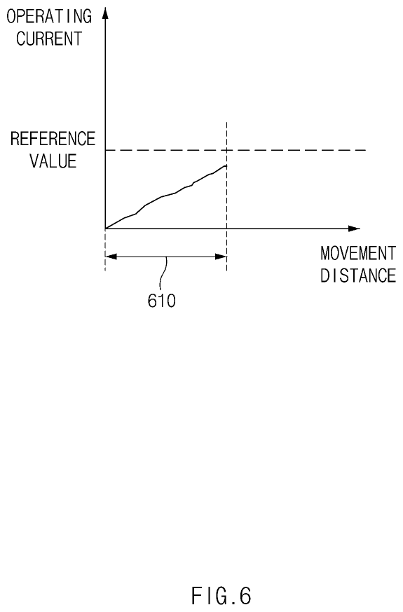

Hereinafter, a process in which the controller 40 determines the slide resistance of the glass run 25 and the torque of the motor 3 satisfying the designer's requirements will be described with reference to FIGS. 5 and 6.

FIG. 5 is a diagram illustrating an example of a process of monitoring an operating current of a motor in a controller provided in an apparatus for predicting performance of a power window according to an embodiment of the present disclosure.

In FIG. 5, the horizontal axis represents time, and the vertical axis represents the operating current of the motor 3. Also, an initial starting period 510 may be ignored because it is the inrush period of the motor 3.

FIG. 6 is a diagram illustrating an example of a process of monitoring an operating time of a motor in a controller provided in an apparatus for predicting performance of a power window according to an embodiment of the present disclosure.

In FIG. 6, the horizontal axis represents the moving distance of the door glass 11, the vertical axis represents the operating time of the motor 3, and reference numeral ‘610’ represents the stroke distance of the door glass 11. In this case, because the motor 3 is connected to the door glass 11 through a regulator, the operating time of the motor 3 may finally mean the movement time of the door glass 11.

First, when the operating current of the motor 3 predicted based on the deep learning model in a normal operation period 520 does not exceed a reference value (reference current), the controller 40 may determine that designer's requirements are satisfied.

Thereafter, when the operating time of the motor 3 does not exceed a reference value (reference time), the controller 40 may determine that the designer's requirements are finally satisfied.

On the other hand, when the operating current of the motor 3 predicted based on the deep learning model in the normal operation period 520 exceeds the reference value, the controller 40 may determine that the slide resistance of the glass run 25 and the torque of the motor 3 are not optimal. In this case, the controller 40 may perform the following replacement process.

That is, the controller 40 may select training data including the stroke distance of the door glass 11 and the weight of the door glass 11 which are similar to the stroke distance of the door glass 11 and the weight of the door glass 11 among the plurality of learning data stored in the memory storage 10, and replace the slide resistance of the glass run 25 and the torque of the motor 3 input through the input device 20 with the slide resistance of the glass run 25 and the torque of the motor 3 included in the selected learning data.

When the operating current of the motor 3 predicted based on the deep learning model in the normal operation period 520 through the replacement process does not exceed the reference value, the controller 40 may determine that the designer's requirements are primarily satisfied.

Thereafter, when the operating time of the motor 3 exceeds the reference value (reference time), the controller 40 may perform the replacement process again.

Through the process, the controller 40 may determine an optimal slide resistance of the glass run 25 and an optimal torque of the motor 3 in which the operating current of the motor 3 predicted based on the deep learning model in the normal operation period 520 does not exceed the reference value, and the operating time of the motor 3 does not exceed the reference value (reference time).

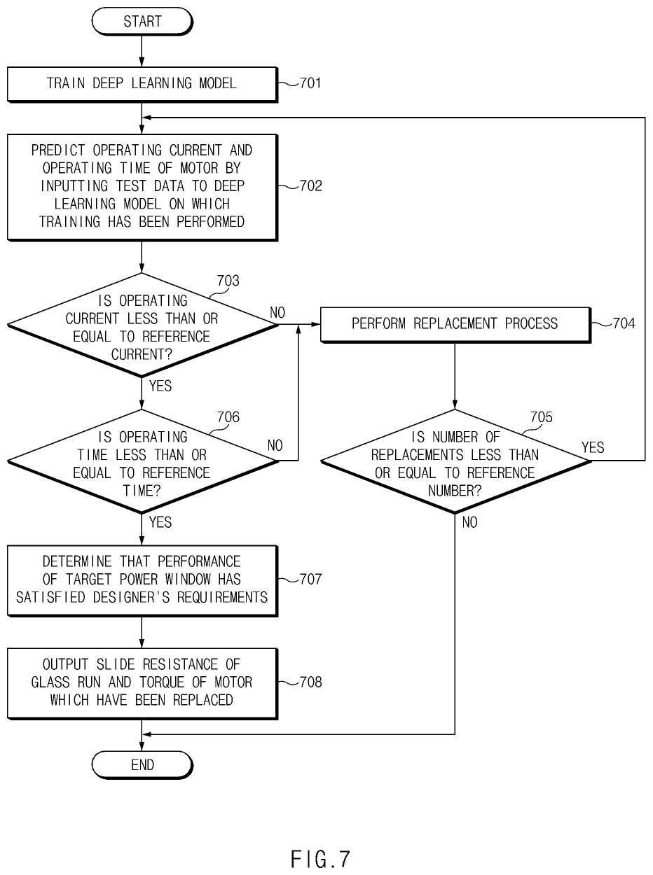

FIG. 7 is a flowchart of a method of predicting performance of a power window according to an embodiment of the present disclosure, and shows a process performed by the controller 40.

First, the controller 40 may train the deep learning model using a plurality of pieces of training data as shown in FIG. 3 (710).

Thereafter, the controller 40 may predict the operating current and operating time of the motor 3 by inputting test data to the deep learning model on which the training has been completed (702). In this case, the test data may represent real data of the power window of which performance is to be predicted, and the operating time of the motor 3 may represent the movement time of the door glass 11.

Thereafter, the controller 40 may determine whether the operating current of the motor 3 is equal to or less than a reference current (703).

As a result of the determination (703), when the operating current of the motor 3 is not equal to or less than the reference current, the controller 40 may perform the above-described replacement process (704).

Thereafter, when the number of replacements is less than or equal to a reference number, the process proceeds to “702”, and ends when the number of replacements is greater than the reference number (705).

As a result of the determination (703), when the operating current of the motor 3 is equal to or less than the reference current, the controller 40 may determine whether the operating time of the motor 3 is equal to or less than the reference time (706).

As a result of the determination (706), when the operating current of the motor 3 is greater than the reference current, the process proceeds to “704”.

As a result of the determination (706), when the operating current of the motor 3 is equal to or less than the reference current, the controller 40 may determine that the performance of a target power window has satisfied the designer's requirements.

Then, the controller 40 may output the slide resistance of the glass run 25 and the torque of the motor 3, which are finally replaced through the above-described replacement process, through the output device 30.

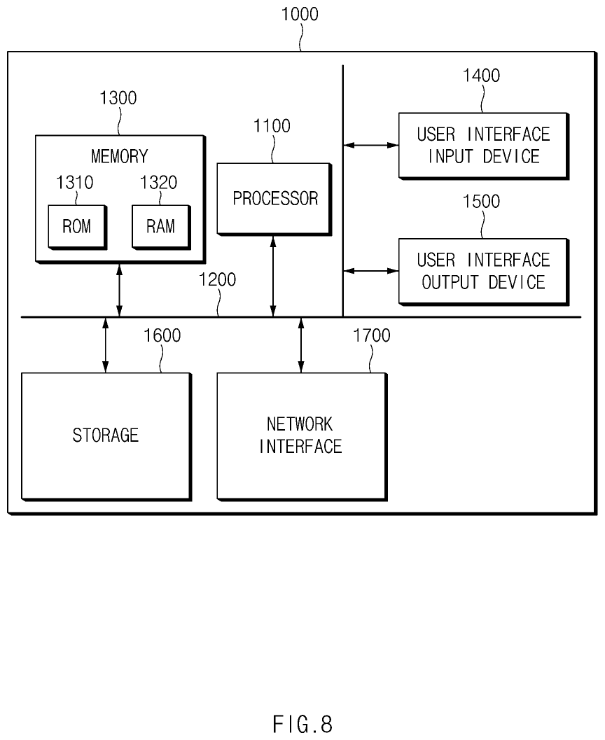

FIG. 8 is a block diagram illustrating a computing system for performing a method for predicting performance of a power window according to an embodiment of the present disclosure.

Referring to FIG. 8, the method for predicting performance of a power window according to an embodiment of the present disclosure as described above may be also implemented through a computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a solid state drive (SSD) a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

According to the apparatus for predicting performance of a power window and the method thereof, it is possible to train a deep learning model to predict the performance of a power window using a slide resistance of a glass run, the stroke distance of a glass, the weight of the glass, the torque of a motor, and the durability of the power window and predict the performance of the target power window based on the deep learning model on which the training has been performed, significantly reducing a required time and providing high-accuracy prediction results compared to a measurement method using an actual measuring device.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for predicting performance of a power window, comprising:
a memory storage configured to store a deep learning model and trained updates thereto; and
a controller configured to:
train the deep learning model to predict the performance of a power window using: a slide resistance of a glass run, a stroke distance of a door glass, a weight of the door glass, a torque of a motor, and a durability of the power window; and
predict performance of a target power window based on the deep learning model and trained updates thereto.

2. The apparatus of claim 1, further comprising:
an input device configured to input: the slide resistance of the glass run, the stroke distance of the door glass, the weight of the door glass, the torque of the motor, and the durability of the power window as real data for the target power window.

3. The apparatus of claim 2, wherein the controller is further configured to predict an operating current and an operating time of the motor as the performance of the target power window by inputting the real data to the deep learning model.

4. The apparatus of claim 2, wherein the controller is further configured to:
replace the slide resistance of the glass run and the torque of the motor with different values in the real data when the predicted performance of the target power window does not satisfy designer's requirements, and
re-perform the predicted performance of the target power window as a re-prediction.

5. The apparatus of claim 4, wherein the controller is further configured to:
select training data including values similar to the stroke distance and weight of the door glass in the real data from among a plurality of pieces of training data, and
replace the slide resistance of the glass run and the torque of the motor in the real data with a slide resistance of the glass run and a torque of the motor in the selected training data.

6. The apparatus of claim 4, wherein the controller is further configured to: determine that the predicted performance of the target power window does not satisfy the designer's requirements when (a) the predicted operating current of the motor is greater than a reference current, and/or (b) the predicted operating time of the motor is greater than a reference time.

7. The apparatus of claim 4, further comprising:
an output device configured to output the predicted performance of the target power window.

8. The apparatus of claim 7, wherein:
the controller is further configured to output the slide resistance of the glass run and the torque of the motor,
the slide resistance of the glass run and the torque of the motor being replaced via the output device when the re-prediction performance of the target power window satisfies the designer's requirements.

9. The apparatus of claim 1, wherein the deep learning model is implemented with a Long Short Term Memory (LSTM).

10. A method for predicting performance of a power window, comprising:
storing, by a memory storage, a deep learning model and trained updates thereto; and
training, by a controller, the deep learning model to predict the performance of a power window using: a slide resistance of a glass run, a stroke distance of a door glass, a weight of the door glass, a torque of a motor, and a durability of the power window; and
predicting, by the controller, performance of a target power window based on the deep learning model and trained updates thereto.

11. The method of claim 10, wherein the predicting of the performance of the target power window step further includes:
receiving, by the controller, the slide resistance of the glass run, the stroke distance of the door glass, the weight of the door glass, the torque of the motor, and the durability of the power window as real data for the target power window; and
predicting, by the controller, an operating current and an operating time of the motor as the performance of the target power window by inputting the real data to the deep learning model.

12. The method of claim 11, wherein the predicting of the performance of the target power window step further includes:
replacing, by the controller, the slide resistance of the glass run and the torque of the motor with different values in the real data when the predicted performance of the target power window does not satisfy designer's requirements, and
re-performing the predicted performance of the target power window as a re-prediction.

13. The method of claim 12, wherein the re-performing of the predicted performance of the target power window step further includes:
selecting, by the controller, training data including values similar to the stroke distance and weight of the door glass in the real data from among a plurality of pieces of training data; and
replacing, by the controller, the slide resistance of the glass run and the torque of the motor in the real data with a slide resistance of the glass run and a torque of the motor in the selected training data.

14. The method of claim 12, wherein the re-performing the predicted performance of the target power window step further includes:
determining, by the controller, that the predicted performance of the target power window does not satisfy the designer's requirements when (a) the predicted operating current of the motor is greater than a reference current, and/or (b) the predicted operating time of the motor is greater than a reference time.

15. The method of claim 12, wherein the predicting of the performance of the target power window step further includes outputting, by the controller, the slide resistance of the glass run and the torque of the motor, the slide resistance of the glass run and the torque of the motor being replaced when the re-prediction performance of the target power window satisfies the designer's requirements.
